(19) United States
(12) Patent Application Publication
(10) Pub. No.: US 2013/0123092 A1
(43) Pub. Date: May 16, 2013

(54) TIO2-CONTAINING QUARTZ GLASS SUBSTRATE AND METHOD FOR PRODUCING SAME

(71) Applicant: Asahi Glass Company, Limited, Chiyoda-ku (JP)

(72) Inventors: Junko MIYASAKA, Tokyo (JP); Akio Koike, Tokyo (JP)

(73) Assignee: Asahi Glass Company, Limited, Chiyoda-ku (JP)

(21) Appl. No.: 13/736,448

(22) Filed: Jan. 8, 2013

Related U.S. Application Data
(63) Continuation of application No. PCT/JP2011/065603, filed on Jul. 7, 2011.

(30) Foreign Application Priority Data
Jul. 8, 2010 (JP) 2010-155691

(51) Int. Cl. C03B 20/00

(52) U.S. Cl. CPC C03B 20/00
USPC 501/53; 65/17.4

(57) ABSTRACT

The present invention relates to a TiO₂-containing quartz glass substrate, having a TiO₂ concentration of from 3 to 8% by mass, an OH concentration of 50 ppm by mass or less, and an internal transmittance T₃₆₅ per 1 mm thickness at a wavelength of 365 nm of 95% or more.

### TECHNICAL FIELD

The present invention relates to a TiO₂-containing quartz glass substrate and a method for producing thereof.

### BACKGROUND ART

As a method for forming a fine concavo-convex pattern having a size of from 1 nm to 10 μm on a surface of various substrates (for example, single crystal substrates of Si, sapphire, and the like, or amorphous substrate of glass and the like) in semiconductor devices, optical waveguides, micro-optical elements (diffraction gratings etc.), biochips, microreactors, and the like, a photoimprint process has attracted much attention, in which an imprint mold having a reverse pattern (transfer pattern) of the concavo-convex pattern on a surface thereof is pressed against a photocurable resin layer formed on a surface of the substrate and the photocurable resin is cured to thereby form the concavo-convex pattern on the surface of the substrate.

The imprint mold for use in the photoimprint process is required to have light transparency, chemical resistance, and dimensional stability against temperature elevation induced by light irradiation. As a substrate for the imprint mold, in view of light transparency and chemical resistance, quartz glass is frequently used. However, quartz glass has such a high coefficient of thermal expansion at around room temperature as about 50 ppb/° C. and thus lacks dimensional stability. Accordingly, as a quartz-based glass having a low coefficient of thermal expansion, a TiO₂-containing quartz glass has been proposed (Patent Documents 1 and 2).

### PRIOR ART DOCUMENTS

### Patent Documents

Patent Document 1: JP-A-2006-306674
Patent Document 2: JP-A-2008-303100

### SUMMARY OF THE INVENTION

### Problems that the Invention is to Solve

However, the coefficient of thermal expansion of the TiO₂-containing quartz glass substrate varies depending on TiO₂ concentration, fictive temperature, and concentration of the other components such as OH. When the OH concentration is high, structural relaxation is promoted and a difference in fictive temperature between the outside and the inside of the glass is liable to be generated. Therefore, distribution of the coefficient of thermal expansion is easily formed. Moreover, when the OH concentration is high, the distribution of the OH concentration increases and thus the distribution of the coefficient of thermal expansion is liable to be formed.

On the other hand, when the OH concentration is low, not only the distribution of the OH concentration is less likely to be formed but also the distribution of the fictive temperature is hardly formed owing to inhibition of the structural relaxation, so that a glass having an even coefficient of thermal expansion is easily obtained.

Moreover, when the OH concentration is high, there arises a problem that cracks are easily generated in the imprint mold.

Accordingly, it is considered to lower the OH concentration of the TiO₂-containing quartz glass substrate. However, when the OH concentration is lowered, Ti³⁺ is liable to be formed through reduction of TiO₂. Since Ti³⁺ absorbs an ultraviolet ray (365 nm), which is employed in the photoimprint process, internal transmittance of the imprint mold at a wavelength of 365 nm decreases. Moreover, as a method for lowering the OH concentration of the TiO₂-containing quartz glass substrate, a method of increasing halogen concentration (particularly fluorine concentration) is known but, when the halogen concentration is increased, there is a problem that Ti³⁺ is further liable to be formed.

The present invention provides a TiO₂-containing quartz glass substrate particularly suitable for obtaining an imprint mold which has high dimensional accuracy and sufficiently high hardness, is less likely to form cracks, and has sufficiently high ultraviolet (365 nm) transmittance, as well as a method for producing the same.

### Means for Solving the Problems

The TiO₂-containing quartz glass substrate of the present invention has a TiO₂ concentration of from 3 to 8% by mass, an OH concentration of 50 ppm by mass or less, and an internal transmittance T₃₆₅ per 1 mm thickness at a wavelength of 365 nm of 95% or more.

The TiO₂-containing quartz glass substrate of the present invention preferably has a halogen concentration of 1,000 ppm by mass or less.

The TiO₂-containing quartz glass substrate of the present invention is preferably used for an imprint mold.

The method for producing a TiO₂-containing quartz glass substrate of the present invention is a method for producing a TiO₂-containing quartz glass substrate having a TiO₂ concentration of from 3 to 8% by mass, containing the following steps (a) to (d):

(a) a step of depositing TiO₂—SiO₂ glass fine particles obtained by flame hydrolysis or thermal decomposition of a glass forming raw material containing an SiO₂ precursor and a TiO₂ precursor to obtain a porous TiO₂—SiO₂ glass body,

(b) a step of heating the porous TiO₂—SiO₂ glass body at 1,000 to 1,300° C. under reduced pressure to obtain an OH-decreased porous TiO₂—SiO₂ glass body,

(c) a step of heating the OH-decreased porous TiO₂—SiO₂ glass body at a densification temperature under an oxygen gas atmosphere or under an atmosphere containing an inert gas and oxygen gas to obtain a TiO₂—SiO₂ dense body, and

(d) a step of heating the TiO₂—SiO₂ dense body at a transparent vitrification temperature to obtain a transparent TiO₂—SiO₂ glass body.

In the production method of the present invention, the TiO₂-containing quartz glass substrate preferably has an OH concentration of 50 ppm by mass or less.

Moreover, in the production method of the present invention, the TiO₂-containing quartz glass substrate preferably has a halogen concentration of 1,000 ppm by mass or less.

Furthermore, in the production method of the present invention, the TiO₂-containing quartz glass substrate preferably has a Ti³⁺ of 4 ppm by mass or less.

### Advantageous Effect of the Invention

According to the TiO₂-containing quartz glass substrate of the present invention, there can be obtained an imprint mold which has high dimensional accuracy and sufficiently high hardness, is less likely to form cracks, and has sufficiently high ultraviolet (365 nm) transmittance.

According to the production method of a TiO₂-containing quartz glass substrate of the present invention, there can be produced a TiO₂-containing quartz glass substrate capable of affording an imprint mold which has high dimensional accuracy and sufficiently high hardness, is less likely to form cracks, and has sufficiently high ultraviolet (365 nm) transmittance. Moreover, it may be also used for other optical members.

### BRIEF DESCRIPTION OF THE DRAWINGS

FIG. 1 is a graph showing the relationship between the TiO₂ concentration and the hardness of the TiO₂-containing quartz glass substrate.

### MODE FOR CARRYING OUT THE INVENTION

### <TiO₂-Containing Quartz Glass Substrate>

### (TiO₂ Concentration)

The TiO₂-containing quartz glass substrate (100% by mass) has a TiO₂ concentration of from 3 to 8% by mass, preferably from 4 to 7.5% by mass, and more preferably from 5 to 7% by mass. In the case where the TiO₂-containing quartz glass substrate is used as a substrate for an imprint mold, dimensional stability against temperature change and hardness are required. When the TiO₂ concentration is 3% by mass or more, the coefficient of thermal expansion at around room temperature can be made small. When the TiO₂ concentration is 8% by mass or less, the hardness becomes sufficiently high.

The TiO₂ concentration is measured on fluorescent X-ray analysis using a fundamental parameter method (FP method).

### (Ti³⁺ Concentration)

The TiO₂-containing quartz glass substrate preferably has a Ti³⁺ concentration of 4 ppm by mass or less, more preferably 3 ppm by mass or less, further preferably 2 ppm by mass or less, and particularly preferably 1 ppm by mass or less on average. The Ti³⁺ concentration is most preferably 0.5 ppm by mass or less. The Ti³⁺ concentration influences coloration of the TiO₂-containing quartz glass, particularly internal transmittance T₃₆₅. When the Ti³⁺ concentration is 4 ppm by mass or less, brown coloration is suppressed and, as a result, decrease in the internal transmittance T₃₆₅ is suppressed and thus transparency becomes good.

The Ti³⁺ concentration is determined by electron spin resonance (ESR: Electron Spin Resonance) measurement. The measurement conditions are as follows.

Frequency: around 9.44 GHz (X-band),

Output: 4 mW,

Modulated magnetic field: 100 KHz, 0.2 mT,

Measurement temperature: room temperature,

ESR species integration range: 332 to 368 mT, and

Sensitivity calibration: carried out at a peak height of a given amount of Mn²⁺/MgO

In the ESR signal (differential form) in which the ordinate axis is signal intensity and the abscissa axis is magnetic field intensity (mT), the TiO₂-containing quartz glass shows a shape having anisotropy of g₁=1.988, g₂=1.946, and g₃=1.915. Since Ti³⁺ in the glass is usually observed at g=around 1.9, they are taken as signals derived from Ti³⁺. The Ti³⁺ concentration is determined by comparing the intensity after twice integration with the corresponding intensity after twice integration of a standard sample whose concentration is known.

### (OH Concentration)

The TiO₂-containing quartz glass substrate has an OH concentration of 50 ppm by mass or less, preferably 45 ppm by mass or less, and more preferably 40 ppm by mass or less. When the OH concentration is 50 ppm by mass or less, in the case where the TiO₂-containing quartz glass substrate is used as an imprint mold, the generation of cracks is inhibited.

The OH concentration is determined by the following method. Measurement using an infrared spectrophotometer is performed and the OH concentration is determined from an absorption peak at a wavelength of 2.7 μm (J. P. Wiiliams et al., Ceramic Bulletin, 55(5), 524, 1976). The detection limit by the method is 0.1 ppm by mass.

### (Halogen Concentration)

The TiO₂-containing quartz glass substrate preferably has a halogen concentration of 1,000 ppm by mass or less, more preferably 500 ppm by mass or less, and further preferably 200 ppm by mass or less. When the halogen concentration is 1,000 ppm by mass or less, the Ti³⁺ concentration hardly increases, so that the brown coloration is less likely to occur. As a result, decrease of T₃₆₅ is inhibited and transparency is not impaired.

The halogen concentration is determined by the following method.

The chlorine, bromine, or iodine concentration is determined by quantitative analysis of respective ion concentration by an ion chromatographic analytical method, for a solution obtained by dissolving a sample into a sodium hydroxide solution under heating followed by filtration through a cation-removing filter.

The fluorine concentration is determined using an FP method (fundamental parameter method) using a sample having a known fluorine concentration by fluorescent X-ray in the case of high concentration (100 ppm by mass or more), or is determined by quantitative analysis of fluorine ion concentration by an ion chromatographic analytical method in the case of low concentration (less than 100 ppm by mass) in the same manner as in the case of the chlorine concentration.

### (Internal Transmittance)

The TiO₂-containing quartz glass substrate has an internal transmittance T₃₆₅ per 1 mm thickness at a wavelength of 365 nm of 95% or more. Since a photocurable resin is cured by ultraviolet irradiation in the photoimprint process, higher transmittance for an ultraviolet ray (365 nm) is preferable.

The TiO₂-containing quartz glass substrate preferably has an internal transmittance T₃₀₀₋₇₀₀ per 1 mm thickness in a wavelength region of from 300 to 700 nm of 70% or more, more preferably 80% or more, further preferably 85% or more, and particularly preferably 90% or more. Since a photocurable resin is cured by ultraviolet irradiation in the photoimprint process, higher transmittance in the ultraviolet region is preferable.

The TiO₂-containing quartz glass substrate preferably has an internal transmittance T₄₀₀₋₇₀₀ per 1 mm thickness in a wavelength region of from 400 to 700 nm of 80% or more, more preferably 85% or more, and further preferably 90% or more. When T₄₀₀₋₇₀₀ is 80% or more, visible light is hardly absorbed and, at inspection by microscope, eye, or the like, the presence or absence of internal defects such as bubbles and striae is easily judged and problems are less likely to occur in inspection and evaluation.

The internal transmittance is determined by the following method.

Using a spectrophotometer, transmittance of a sample (mirror-polished TiO₂-containing quartz glass substrate) is measured. The internal transmittance per 1 mm thickness is determined by measuring respective transmittance of samples different in thickness, which are mirror-polished to the same degree, for example, a sample having 2 mm thickness and a sample having 1 mm thickness, converting the transmittance into absorbance, subsequently subtracting the absorbance of the sample having 1 mm thickness from the absorbance of the sample having 2 mm thickness to determine absorbance per 1 mm thickness, and again converting it into transmittance.

A quartz glass having about 1 mm thickness, which has been mirror-polished to the same degree as in the case of the sample, is prepared. A decrease of transmittance of the quartz glass at a wavelength at which the quartz glass does not absorb, for example, a wavelength of around 2,000 nm, is taken as reflection loss at front surface and back surface. The decrease of transmittance is converted into absorbance, which is taken as absorbance of reflection loss at front surface and back surface.

The transmittance of a sample having 1 mm thickness in a wavelength region of measuring the internal transmittance is converted into absorbance and the absorbance of the quartz glass at a wavelength of 2,000 nm is subtracted therefrom. The difference in absorbance is again converted into transmittance, which is taken as internal transmittance.

### (Stress)

The TiO₂-containing quartz glass substrate preferably has a standard deviation (dev[σ]) of stress caused by striae of 0.05 MPa or less, more preferably 0.04 MPa or less, and further preferably 0.03 MPa or less. Usually, a glass body produced by a soot process to be mentioned later is also said to be three-direction striae-free, in which striae are not observed. However, even in the case of a glass body produced by the soot process, there is a possibility that striae are observed when a dopant (TiO₂ or the like) is contained. When striae are present, it is difficult to obtain a surface having little roughness and waving. Moreover, for the same reason, the TiO₂-containing quartz glass substrate preferably has a difference (Δσ) between the maximum value and the minimum value of stress caused by striae of 0.23 MPa or less, more preferably 0.2 MPa or less, and further preferably 0.15 MPa or less.

The stress is determined by the following method.

First, retardation of a sample is determined by measuring a region of about 1 mm×1 mm using a birefringence microscope, and profile of stress is determined from the following equation (1).

Δ=C×F×n×d (1)

Here, Δ is retardation, C is a photoelastic constant, F is stress, n is a refractive index, and d is a thickness of the sample.

Then, the standard deviation (dev[σ]) of stress and the difference (Δσ) between the maximum value and the minimum value of stress are determined from the profile of stress.

Specifically, a sample is cut out of a TiO₂-containing quartz glass substrate by slicing, followed by polishing, thereby obtaining a plate-shaped sample of 30 mm×30 mm×0.5 mm. Using a birefringence microscope, helium neon laser light is vertically applied to a 30 mm×30 mm surface of the sample, in-plane retardation distribution is examined by magnifying to a magnification capable of observing striae well, and the retardation distribution is converted to stress distribution. When pitch of striae is fine, the thickness of the sample is required to be small.

### (Coefficient of Thermal Expansion)

The TiO₂-containing quartz glass substrate preferably has a coefficient of thermal expansion C₁₅₋₃₅ at 15 to 35° C. being in the range of 0±200 ppb/° C. In the case when used as a substrate for an imprint mold, the TiO₂-containing quartz glass substrate is required to have excellent dimensional stability against temperature change, more specifically, dimensional stability against temperature change in a temperature region which may be experienced by the mold in imprint process. Here, the temperature region which may be experienced by the mold varies depending on kind of the imprint process. In the photoimprint process, since a photocurable resin is cured by irradiation with an ultraviolet ray, the temperature region which may be experienced by the mold is fundamentally around room temperature. However, the temperature of the mold is locally elevated by the irradiation with an ultraviolet ray in some cases. In consideration of the local temperature elevation by the ultraviolet ray irradiation, the temperature region which may be experienced by the mold is set to be from 15 to 35° C. C₁₅₋₃₅ is more preferably in the range of 0±100 ppb/° C., further preferably in the range of 0±50 ppb/° C., and particularly preferably in the range of 0±20 ppb/° C.

The TiO₂-containing quartz glass substrate preferably has a coefficient of thermal expansion C₂₂ at 22° C. of 0±30 ppb/° C., more preferably 0±10 ppb/° C., and further preferably 0±5 ppb/° C. When C₂₂ is in the range of 0±30 ppb/° C., the dimensional change by temperature change is negligible, irrespective of whether the value is positive or negative.

In order to make a precise measurement by a small number of measuring points as in the case of the coefficient of thermal expansion at 22° C., dimensional change of a sample by temperature change of 1 to 3° C. lower and higher the objective temperature is measured using a laser heterodyne interference thermal dilatometer (for example, CTE-01 manufactured by Uniopt Company, etc.) and an average coefficient of thermal expansion thereof is taken as the coefficient of thermal expansion at the middle temperature.

### (Hardness)

The TiO₂—SiO₂ glass substrate preferably has a Vickers Hardness of 650 or more, further preferably 660 or more, and particularly preferably 690 or more.

Vickers Hardness is determined as follows.

Using a Vickers Hardness meter, a Vickers indenter is pressed into a polished surface of a sample at a load of 100 gf (0.98N) and diagonal length d (μm) of indentation is measured. From the diagonal length d of indentation, Vickers Hardness VHN is calculated using the following equation (2).

VHN=1854.4×100/d² (2)

### (Function and Effect)

In the TiO₂-containing quartz glass substrate described above, since the TiO₂ concentration is from 3 to 8% by mass, an imprint mold having high dimensional accuracy and sufficiently high hardness can be obtained. Moreover, since the OH concentration is 50 ppm by mass or less, an imprint mold in which cracks are hardly formed can be obtained. Furthermore, since the internal transmittance T₃₆₅ per 1 mm thickness at a wavelength of 365 nm is 95% or more, an imprint mold having sufficiently high transmittance for an ultraviolet ray (365 nm) can be obtained. In addition, it can be also used for other optical members.

### <Method for Producing TiO₂-Containing Quartz Glass Substrate>

The method for producing a TiO₂-containing quartz glass substrate (hereinafter also referred to as TiO₂—SiO₂ glass substrate) of the present invention is a method containing the following steps (a) to (g).

(a) A step of depositing TiO₂—SiO₂ glass fine particles obtained by hydrolysis or thermal decomposition of a glass forming raw material containing an SiO₂ precursor and a TiO₂ precursor to obtain a porous TiO₂—SiO₂ glass body.

(b) A step of heating the porous TiO₂—SiO₂ glass body at 1,000 to 1,300° C. under reduced pressure to obtain an OH-decreased porous TiO₂—SiO₂ glass body.

(c) A step of heating the OH-decreased porous TiO₂—SiO₂ glass body at a densification temperature under an oxygen gas atmosphere or under an atmosphere containing an inert gas and oxygen gas to obtain a TiO₂—SiO₂ dense body.

(d) A step of heating the TiO₂—SiO₂ dense body to a transparent vitrification temperature to obtain a transparent TiO₂—SiO₂ glass body.

(e) A step of heating the transparent TiO₂—SiO₂ glass body to a softening point thereof or higher and molding it to obtain a molded TiO₂—SiO₂ glass body, according to need.

(f) A step of annealing the transparent TiO₂—SiO₂ glass body obtained in step (d) or the molded TiO₂—SiO₂ glass body obtained in step (e), according to need.

(g) A step of subjecting the transparent TiO₂—SiO₂ glass body obtained in step (d), the molded TiO₂—SiO₂ glass body obtained in step (e), or the TiO₂—SiO₂ glass body obtained in step (f) to mechanical processing such as severing, cutting, and polishing to thereby obtain a TiO₂—SiO₂ glass substrate having a predetermined shape.

### (Step (a))

TiO₂—SiO₂ glass fine particles (soot) obtained by flame hydrolysis or thermal decomposition of an SiO₂ precursor and a TiO₂ precursor each serving as a glass forming raw material are deposited and grown on a substrate for deposition to form a porous TiO₂—SiO₂ glass body.

The soot process includes MCVD process, OVD process, and VAD process. Of these, the VAD process is preferable because of excellent mass productivity and capability of providing a glass having a homogeneous composition in large in-plane area by adjusting production conditions such as a size of a substrate for deposition.

The glass forming raw materials include raw materials capable of being gasified.

The SiO₂ precursor includes silicon halide compounds and alkoxysilanes.

The TiO₂ precursor includes titanium halide compounds and alkoxytitaniums.

The silicon halide compounds include chlorides (SiCl₄, SiHCl₃, SiH₂Cl₂, SiH₃Cl, etc.), fluorides (SiF₄, SiHF₃, SiH₂F₂, etc.), bromides (SiBr₄, SiHBr₃, etc), and iodides (SiI₄ etc.).

The alkoxysilanes include compounds represented by the following formula (3).

RₙSi(OR)₄₋ₙ (3)

Here, R represents an alkyl group having carbon number of from 1 to 4, n is an integer of from 0 to 3, and a part of plural Rs may be different from the others.

The titanium halide compounds include TiCl₄, TiBr₄, and the like.

The alkoxytitaniums include compounds represented by the following formula (4).

RₙTi(OR)₄₋ₙ (4)

Here, R represents an alkyl group having carbon number of from 1 to 4, n is an integer of from 0 to 3, and a part of plural Rs may be different from the others.

In addition, compounds containing Si and Ti, such as silicon titanium double alkoxide, can be used as the SiO₂ precursor and TiO₂ precursor.

The substrate for deposition includes a quartz glass-made seed rod (for example, seed rod described in Japanese Examined Patent Application Publication No. 63-24937). The substrate is not limited to a rod shape, and a plate-shaped substrate may be used.

### (Step (b))

The porous TiO₂—SiO₂ glass body obtained in step (a) is heated at 1,000 to 1,300° C. under reduced pressure to obtain an OH-decreased porous TiO₂—SiO₂ glass body.

By conducting step (b), OH concentration of the porous TiO₂—SiO₂ glass body can be reduced.

The heating temperature in step (b) is from 1,000 to 1,300° C. and preferably from 1,100 to 1,200° C. When the heating temperature is 1,000° C. or higher, OH concentration of the porous TiO₂—SiO₂ glass body can be sufficiently reduced. When the heating temperature is 1,300° C. or lower, OH concentration can be efficiently reduced without densifying the porous TiO₂—SiO₂ glass body.

The heating time in step (b) is preferably 100 hours or less and more preferably 50 hours or less in view of cost saving. Moreover, the heating time is preferably 10 hours or more and more preferably 20 hours or more in view of the OH-decreasing effect.

The pressure (absolute pressure) in step (b) is preferably 0.1 Pa or less, more preferably 0.05 Pa or less, and further preferably 0.01 Pa or less. When the pressure (absolute pressure) is 0.1 Pa or less, OH concentration of the porous TiO₂—SiO₂ glass body can be sufficiently reduced by degassing of the porous TiO₂—SiO₂ glass body.

### (Step (c))

The OH-decreased porous TiO₂—SiO₂ glass body obtained in step (b) is heated to a densification temperature under an oxygen gas atmosphere or under an atmosphere containing an inert gas and oxygen gas to obtain a TiO₂—SiO₂ dense body. The holding time at the densification temperature or higher is preferably from 1 to 100 hours and further preferably from 2 to 50 hours.

By conducting step (c) under an atmosphere containing oxygen gas (oxidation condition), formation of Ti³⁺ is inhibited. Although the formation of Ti³⁺ can be inhibited by conducting an oxidation treatment in an oxygen atmosphere after densification under an atmosphere containing no oxygen, a long-term thermal treatment is required in this method. When the long-term thermal treatment is conducted, impurities are liable to diffuse, which causes crystallization. Densification under an atmosphere containing oxygen gas can inhibit the formation of Ti³⁺ without the long-term thermal treatment under an oxygen atmosphere.

The dew point of the mixed gas containing an inert gas and oxygen gas is preferably −50° C. or lower and more preferably −60° C. or lower in view of OH-decreasing.

The inert gas is preferably helium.

The pressure of the oxygen atmosphere or the atmosphere containing an inert gas and oxygen gas is preferably normal pressure or reduced pressure. In the case of reduced pressure, the pressure is preferably 13,000 Pa or less. In the case of containing oxygen gas and an inert gas, the ratio of oxygen gas is preferably from 10% by volume to 100% by volume.

The densification temperature means a temperature at which a porous TiO₂—SiO₂ glass body can be densified until pores cannot be observed on an optical microscope.

The densification temperature is preferably from 1,250 to 1,550° C., and further preferably from 1,350 to 1,450° C.

In step (c), it is preferred that the OH-decreased porous TiO₂—SiO₂ glass body is placed under reduced pressure (preferably 13,000 Pa or less, more preferably 1,300 Pa or less), and a mixed gas containing an inert gas and oxygen gas is then introduced to form an atmosphere of a given pressure containing the inert gas and oxygen gas, because homogeneity of the TiO₂—SiO₂ dense body is increased.

Furthermore, in step (c), it is preferred that the OH-decreased porous TiO₂—SiO₂ glass body is held at room temperature or a temperature lower than the densification temperature under an atmosphere containing an inert gas and oxygen gas, and then heated to the densification temperature, because homogeneity of the TiO₂—SiO₂ dense body is increased.

### (Step (d))

The TiO₂—SiO₂ dense body obtained in step (c) is heated to a transparent vitrification temperature to obtain a transparent TiO₂—SiO₂ glass body.

The transparent vitrification temperature means a temperature at which crystals cannot be confirmed on an optical microscope and a transparent glass is obtained.

The transparent vitrification temperature is preferably from 1,350 to 1,750° C., and more preferably from 1,400 to 1,700° C.

The atmosphere is preferably an atmosphere of 100% inert gas (helium, argon, or the like), or an atmosphere containing an inert gas (helium, argon, or the like) as a main component.

The pressure of the atmosphere is preferably ordinary pressure or reduced pressure. In the case of reduced pressure, the pressure is preferably 13,000 Pa or lower.

### (Step (e))

The transparent TiO₂—SiO₂ glass body obtained in step (d) is placed in a mold, heated to a temperature higher than the softening point, and molded into a desired shape, thereby obtaining a molded TiO₂—SiO₂ glass body.

The molding temperature is preferably from 1,500 to 1,800° C. When the molding temperature is 1,500° C. or higher, viscosity of the transparent TiO₂—SiO₂ glass body is decreased and the glass is prone to deform by the weight itself. Furthermore, growth of cristobalite which is a crystal phase of SiO₂, or growth of rutile or anatase which is a crystal phase of TiO₂ is suppressed, and a so-called devitrification is hard to occur. When the molding temperature is 1,800° C. or lower, sublimation of SiO₂ is inhibited.

Step (e) may be repeated more than once. For example, it may be possible to perform two-stage molding wherein, after the transparent TiO₂—SiO₂ glass body is placed in a mold and heated to a temperature higher than the softening point, the molded TiO₂—SiO₂ glass body obtained is placed in another mold and heated to a temperature higher than the softening point.

Moreover, step (d) and step (e) can be conducted sequentially or simultaneously.

Furthermore, in the case where the transparent TiO₂—SiO₂ glass body obtained in step (d) has sufficiently large size, step (e) is not conducted, and the transparent TiO₂—SiO₂ glass body obtained in step (d) is cut into a given size, thereby providing a molded TiO₂—SiO₂ glass body.

Also, instead of step (e) or after step (e) and before step (f), the following step (e′) may be conducted.

(Step (e′))

(e′) A step of heating the transparent TiO₂—SiO₂ glass body obtained in step (d) or the molded TiO₂—SiO₂ glass body obtained in step (e) at a temperature of T₁+400° C. or higher for 20 hours or more.

T₁ is an annealing point (° C.) of a TiO₂—SiO₂ glass body obtained in step (f). The annealing point means a temperature at which viscosity η of a glass becomes 1,013 dPa·s. The annealing point is determined as follows.

The viscosity of a glass is measured by a beam bending method in accordance with the method defined in JIS R 3103-2: 2001 and a temperature at which the viscosity η of the glass becomes 1,013 dPa·s is taken as the annealing point.

Striae in the TiO₂—SiO₂ glass body are reduced by carrying out step (e′).

The striae are inhomogeneity on composition (composition distribution) of a TiO₂—SiO₂ glass body. A TiO₂—SiO₂ glass body having striae has several sites having different TiO₂ concentration. Here, the site having a high TiO₂ concentration has negative coefficient of thermal expansion (CTE). Therefore, the site having a high TiO₂ concentration tends to expand in the temperature decreasing process in step (f). In this case, if the site having a low TiO₂ concentration is present adjacent to the site having a high TiO₂ concentration, expansion of the site having a high TiO₂ concentration is inhibited, resulting in addition of compression stress. As a result, distribution of stress is generated in the TiO₂—SiO₂ glass body. In the present specification, such distribution of stress is referred to as “distribution of stress caused by striae”.

If such distribution of stress caused by striae is present in a TiO₂—SiO₂ glass body used as a substrate for an imprint mold, difference in processing rate occurs when the surface is polished, and this affects roughness and waving of the surface after the polishing.

By conducting step (e′), the distribution of stress caused by striae in the TiO₂—SiO₂ glass body produced through step (f) to be subsequently conducted is reduced to a level free of the problem in being used as a substrate for an imprint mold.

The heating temperature in step (e′) is preferably lower than T₁+600° C., more preferably lower than T₁+550° C., and further preferably lower than T₁+500° C. in view of suppressing foaming and sublimation in the TiO₂—SiO₂ glass body. That is, the heating temperature in step (e′) is preferably T₁+400° C. or higher and lower than T₁+600° C., more preferably T₁+400° C. or higher and lower than T₁+550° C., and further preferably T₁+450° C. or higher and lower than T₁+500° C.

The heating time in step (e′) is preferably 240 hours or less, and more preferably 150 hours or less in view of a balance between the effect of reduction of striae and yield of the TiO₂—SiO₂ glass body and cost saving. Moreover, the heating time is preferably more than 24 hours, more preferably more than 48 hours, and further preferably more than 96 hours in view of the effect of reduction of striae.

Step (e′) and step (f) can be conducted sequentially or simultaneously. Furthermore, step (e′) can be conducted sequentially or simultaneously with step (d) and/or step (e).

### (Step (f))

After heated to a temperature of 1,100° C. or higher, the transparent TiO₂—SiO₂ glass body obtained in step (d), the molded TiO₂—SiO₂ glass body obtained in step (e) or the TiO₂—SiO₂ glass body after step (e′) is subjected to an annealing treatment of cooling to a temperature of 700° C. or lower at an average temperature decreasing rate of 100° C./hr or less, thereby controlling the fictive temperature of the TiO₂—SiO₂ glass body.

In the case where step (d) or step (e) (or step (e′)) is conducted sequentially or simultaneously with step (f), in the temperature decreasing process from a temperature of 1,100° C. or higher in step (d) or step (e) (or step (e′)), the transparent TiO₂—SiO₂ glass body or the molded TiO₂—SiO₂ glass body obtained is subjected to an annealing treatment of cooling from 1,100° C. to 700° C. at an average temperature decreasing rate of 100° C./hr or less, thereby controlling the fictive temperature of the TiO₂—SiO₂ glass body.

The average temperature decreasing rate is more preferably 10° C./hr or less, further preferably 5° C./hr or less, and particularly preferably 2.5° C./hr or less.

Moreover, after cooling to a temperature of 700° C. or lower, natural cooling can be performed. The atmosphere is not particularly limited.

In order to eliminate inclusions such as foreign matters and bubbles from the TiO₂—SiO₂ glass to be obtained in step (f), it is required in steps (a) to (e) (particularly in step (a)) to inhibit contamination and to precisely control the temperature conditions of steps (c) to (e).

### (Step (g))

The transparent TiO₂—SiO₂ glass body obtained in step (d), the molded TiO₂—SiO₂ glass body obtained in step (e), or the TiO₂—SiO₂ glass body obtained in step (f) is subjected to mechanical processing such as severing, cutting, and polishing, thereby obtaining a TiO₂—SiO₂ glass substrate having a given shape.

The polishing step is preferably conducted with dividing the step into two or more steps according to a finished condition of a polished surface thereof.

### (Function and Effect)

The method for producing a TiO₂-containing quartz glass substrate of the present invention described above is a method for producing a TiO₂-containing quartz glass substrate having a TiO₂ concentration of from 3 to 8% by mass. In the case when used as an imprint mold, there can be produced a TiO₂-containing quartz glass substrate capable of affording an imprint mold which has high dimensional accuracy and sufficiently high hardness.

Moreover, since the porous TiO₂—SiO₂ glass body obtained in step (a) is heated at 1,000 to 1,300° C. under reduced pressure in step (b), OH concentration thereof can be controlled to 50 ppm by mass or less. As a result, a TiO₂-containing quartz glass substrate capable of affording an imprint mold in which cracks are hardly formed can be produced.

Furthermore, since the densification in step (c) is performed under an oxygen gas atmosphere or under an atmosphere containing an inert gas and oxygen gas, the formation of Ti³⁺ is inhibited in spite of low OH concentration and, as a result, there can be produced a TiO₂-containing quartz glass substrate capable of affording an imprint mold having sufficiently high transmittance for an ultraviolet ray (365 nm) such that internal transmittance T₃₆₅ per 1 mm thickness at a wavelength of 365 nm is 95% or more.

### <Imprint Mold>

The TiO₂-containing quartz glass substrate of the present invention is suitable for an imprint mold. Which can be produced by forming a transfer pattern on a major front surface of the TiO₂-containing quartz glass substrate of the present invention by etching.

The transfer pattern is a reverse pattern of an objective fine concavo-convex pattern and containing plurality of fine convex parts and/or concave parts.

As the etching method, dry etching is preferred and specifically, reactive ion etching with SF₆ is preferred.

### EXAMPLES

The present invention is described in more detail below with reference to Examples, but the present invention is not construed as being limited thereto.

Examples 1 and 2 are Inventive Examples, and Examples 3 to 8 are Comparative Examples.

### Example 1

### (Step (a))

TiO₂—SiO₂ glass fine particles obtained by gasifying TiCl₄ and SiCl₄ each serving as a glass forming raw material, respectively, then mixing them, and subjecting the mixture to heat hydrolysis (flame hydrolysis) in oxyhydrogen flame were deposited and grown on a substrate for deposition to form a porous TiO₂—SiO₂ glass body. The ratio of TiCl₄ and SiCl₄ was adjusted so that the TiO₂ concentration in the TiO₂—SiO₂ glass body became 6.2% by mass.

Since it was hard to handle the porous TiO₂—SiO₂ glass body obtained without any treatment, it was held in the air at 1,200° C. for 4 hours in the state still deposited on the substrate for deposition, and then separated from the substrate for deposition.

### (Step (b))

The porous TiO₂—SiO₂ glass body obtained was held at 1,170° C. for 50 hours under a pressure of 0.01 Pa (absolute pressure), thereby obtaining an OH-decreased porous TiO₂—SiO₂ glass body.

### (Step (c))

The OH-decreased porous TiO₂—SiO₂ glass body obtained was held at 1,450° C. for 4 hours under an atmosphere of a mixed gas consisting of helium gas and oxygen gas (helium gas: 80% by volume, oxygen gas 20% by volume, dew point of the mixed gas: −62° C.), to obtain a TiO₂—SiO₂ dense body.

### (Step (d))

The TiO₂—SiO₂ dense body obtained was placed in a carbon mold, and held at 1,700° C. for 4 hours, thereby obtaining a transparent TiO₂—SiO₂ glass body.

### Example 2

A transparent TiO₂—SiO₂ glass body was obtained in the same manner as in Example 1, except that the composition of the glass forming raw material was adjusted so that the TiO₂ concentration became 7.4% by mass.

### Example 3

A transparent TiO₂—SiO₂ glass body was obtained in the same manner as in Example 1, except that the composition of the glass forming raw material was adjusted so that the TiO₂ concentration became 8.5% by mass.

### Example 4

A transparent TiO₂—SiO₂ glass body was obtained in the same manner as in Example 1, except that step (b) was not conducted.

### Example 5

A transparent TiO₂—SiO₂ glass body was obtained in the same manner as in Example 1, except that step (c) was changed to the following step (c′).

(Step (c′))

The OH-decreased porous TiO₂—SiO₂ glass body obtained was held at 1,450° C. for 4 hours under a helium gas atmosphere, thereby obtaining a TiO₂—SiO₂ dense body.

### Example 6

A transparent TiO₂—SiO₂ glass body was obtained in the same manner as in Example 1, except that step (b) was changed to the following step (b′).

(Step (b′))

The porous TiO₂—SiO₂ glass body obtained was held under conditions of a pressure of 0.21 MPa in gauze pressure and a temperature of 140° C. for 24 hours under an atmosphere of a mixed gas obtained by diluting fluorine simple substance (F₂) with nitrogen gas so as to be 20 mol %, thereby obtaining a fluorine-containing porous TiO₂—SiO₂ glass body.

### Example 7

An ultra-low expansion glass (ULE, manufactured by Corning Incorporated) was prepared.

### Example 8

A transparent TiO₂—SiO₂ glass body was obtained in the same manner as in Example 1, except that step (b) was not conducted and step (c) was changed to the following step (c″).

(Step (c″))

The porous TiO₂—SiO₂ glass body obtained was held at 1,450° C. for 4 hours under a helium gas atmosphere with transferring it in a zone heating electric furnace, thereby obtaining a TiO₂—SiO₂ dense body.

### [Evaluation]

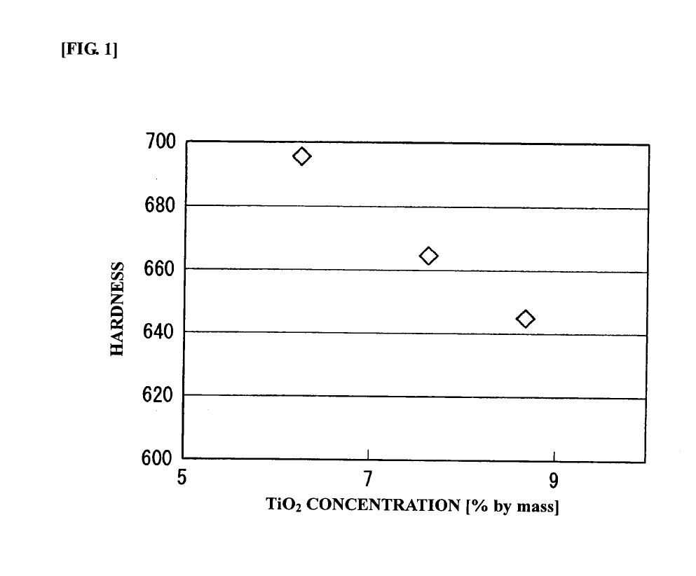

For the transparent TiO₂—SiO₂ glass bodies obtained, TiO₂ concentration, Ti³⁺ concentration, OH concentration, fluorine concentration, chlorine concentration, and internal transmittance were determined by the aforementioned methods. The results are shown in Tables 1 and 2. Moreover, for Example 1, stress and coefficient of thermal expansion were determined by the aforementioned methods. The results are shown in Table 3. Furthermore, for Examples 1 to 3, hardness was determined by the aforementioned method. The results are shown in Table 4. In addition, for Examples 1 to 4, 7, and 8, evaluation of cracks was performed by the following method. The results are shown in Table 4. Further, the relationship between the TiO₂ concentration and the hardness for Examples 1 to 3 is shown in a graph (FIG. 1).

### (Crack)

Using a Vickers durometer, a Vickers indenter was driven into a sample at a load of 100 gf (0.98N) in dry nitrogen having a dew point of −80° C. and, after 30 seconds, the periphery of indentation was observed. The case where cracks were not generated was evaluated as “A” and the case where cracks were generated was evaluated as “B”.

TABLE 1

| | TiO₂ | Ti³⁺ | OH | Chlorine | Fluorine |
|---|---|---|---|---|---|
| | concen- | concen- | concen- | concen- | concen- |
| | tration | tration | tration | tration | tration |
| Example | [% by mass] | [wt ppm] | [wt ppm] | [wt ppm] | [wt ppm] |
| 1 | 6.2 | 0.3 | 40 | <1 | <1 |
| 2 | 7.4 | 0.3 | 45 | <1 | <1 |
| 3 | 8.5 | 0.4 | 45 | <1 | <1 |
| 4 | 6.2 | 0.3 | 80 | <1 | <1 |
| 5 | 6.2 | 4.6 | 45 | <1 | <1 |
| 6 | 6.2 | 7.9 | <2 | <1 | 1060 |
| 7 | 7.4 | 0.7 | 880 | <1 | <1 |
| 8 | 6.2 | 0.4 | 150 | <1 | <1 |

TABLE 2

| | T₃₆₅ | T₃₀₀₋₇₀₀ | T₄₀₀₋₇₀₀ |
|---|---|---|---|
| Example | [%] | [%] | [%] |
| 1 | 96.5 | 94.1 | 98.0 |
| 2 | 96.0 | 93.4 | 96.8 |
| 3 | 96.0 | 92.0 | 95.5 |
| 4 | 97.0 | 96.2 | 98.0 |
| 5 | 80.2 | 72.0 | 74.0 |
| 6 | 52.3 | 56.2 | 59.7 |
| 7 | 96.6 | 89.6 | 95.9 |
| 8 | 96.2 | 94.0 | 97.8 |

TABLE 3

| | | | Coefficient | |
|---|---|---|---|---|
| | | | of thermal | Coefficient |
| | | | expansion at | of thermal |
| | | | 15 to 35° C. | expansion at |
| | dev[σ] | Δσ | C₁₅₋₃₅ | 22° C. C₂₂ |
| Example | [MPa] | [MPa] | [ppb/° C.] | [ppb/° C.] |
| 1 | 0.06 | 0.13 | −32 to 61 | 0 ± 5 |

TABLE 4

| Example | Hardness | Crack |
|---|---|---|
| 1 | 695 | A |
| 2 | 665 | A |
| 3 | 645 | A |
| 4 | — | B |
| 7 | — | B |
| 8 | — | B |

In Example 2, since the TiO₂ concentration was slightly high, hardness slightly decreased, as compared with Example 1.

In Example 3, since the TiO₂ concentration exceeds 8% by mass, hardness was insufficient.

In Example 4, since the OH-decreasing of step (b) was not conducted, OH concentration was high and cracks were generated.

In Example 5, since the densification of step (c) was not performed under an atmosphere containing oxygen gas, Ti³⁺ concentration became high and the internal transmittance T₃₆₅ decreased.

In Example 6, since the OH-decreasing was performed by direct fluorination, fluorine concentration was high, Ti³⁺ concentration became high, and the internal transmittance T₃₆₅ decreased.

In Example 7, OH concentration was high and cracks were generated.

In Example 8, OH concentration was high and cracks were generated.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2010-155691 filed on Jul. 8, 2010, and the contents are incorporated herein by reference.

### INDUSTRIAL APPLICABILITY

The TiO₂-containing quartz glass substrate of the present invention is useful as a material for an imprint mold to be used for the purpose of forming a fine concavo-convex pattern having a size of from 1 nm to 10 μm in semiconductor devices, optical waveguides, micro-optical elements (diffraction gratings etc.), biochips, microreactors, and the like.

1. A TiO₂-containing quartz glass substrate, having
a TiO₂ concentration of from 3 to 8% by mass,
an OH concentration of 50 ppm by mass or less, and
an internal transmittance T₃₆₅ per 1 mm thickness at a wavelength of 365 nm of 95% or more.

2. The TiO₂-containing quartz glass substrate according to claim 1, having a halogen concentration of 1,000 ppm by mass or less.

3. The TiO₂-containing quartz glass substrate according to claim 1, having a Ti³⁺ of 4 ppm by mass or less.

4. The TiO₂-containing quartz glass substrate according to claim 1, which is used for an imprint mold.

5. The TiO₂-containing quartz glass substrate according to claim 2, which is used for an imprint mold.

6. The TiO₂-containing quartz glass substrate according to claim 3, which is used for an imprint mold.

7. A method for producing a TiO₂-containing quartz glass substrate having a TiO₂ concentration of from 3 to 8% by mass, comprising the following steps (a) to (d):
(a) a step of depositing TiO₂—SiO₂ glass fine particles obtained by flame hydrolysis or thermal decomposition of a glass forming raw material containing an SiO₂ precursor and a TiO₂ precursor, to obtain a porous TiO₂—SiO₂ glass body,
(b) a step of heating the porous TiO₂—SiO₂ glass body at 1,000 to 1,300° C. under reduced pressure, to obtain an OH-decreased porous TiO₂—SiO₂ glass body,
(c) a step of heating the OH-decreased porous TiO₂—SiO₂ glass body at a densification temperature under an oxygen gas atmosphere or under an atmosphere containing an inert gas and oxygen gas, to obtain a TiO₂—SiO₂ dense body, and
(d) a step of heating the TiO₂—SiO₂ dense body at a transparent vitrification temperature, to obtain a transparent TiO₂—SiO₂ glass body.

8. The production method according to claim 7, wherein the TiO₂-containing quartz glass has an OH concentration of 50 ppm by mass or less.

9. The production method according to claim 7, wherein the TiO₂-containing quartz glass has a halogen concentration of 1,000 ppm by mass or less.

10. The production method according to claim 7, wherein the TiO₂-containing quartz glass has a Ti³⁺ of 4 ppm by mass or less.
